(19) United States
(12) Patent Application Publication
(10) Pub. No.: US 2015/0271821 A1
(43) Pub. Date: Sep. 24, 2015

(54) Combined digital television and FM radio station

(71) Applicant: Richard D. Bogner, Roslyn, NY (US)

(72) Inventor: Richard D. Bogner, Roslyn, NY (US)

(21) Appl. No.: 14/121,967

(22) Filed: Nov. 10, 2014

Related U.S. Application Data
(60) Provisional application No. 61/967,385, filed on Mar. 18, 2014.

(51) Int. Cl. H04W 72/04; H04L 5/06

(52) U.S. Cl. CPC H04W 72/0453; H04L 5/06

(57) ABSTRACT

A digital television (DTV) station which, in addition to broadcasting a digital television signal, also broadcasts simultaneously one or more analog FM radio signals, using part of the same spectrum allocated to the digital TV station.

It is a general object of this invention to permit a digital TV station to use part of its allocated channel to simultaneously broadcast one or more analog FM radio signals for reception by the public. A second object is to allow current radio receivers to receive signals from a channel six digital TV station.

There exists now a shortage of available spectrum for radio, television, and wireless services. Specifically, there is a critical need for more and improved radio service. I have discovered an unexpected characteristic of recently adopted digital television, which replaced analog television in the United States. Under certain conditions, a digital TV station can simultaneously broadcast a frequency modulated (FM) radio signal, utilizing part of the same spectrum, or channel, which said TV station has been allocated for digital TV. In the U.S., six megahertz (MHz) is allocated by the Federal Communications Commission (FCC) to each TV station. About 5½ MHz of this 6 MHz is used to broadcast this digital TV signal. The remaining approximately ½ MHz is normally not used; ie it is wasted. However, I have found that this unused spectrum can be employed to simultaneously transmit one or more FM radio signals, along with the digital TV signal, without interfering with, or being interfered by, the digital TV signal with which it shares the allocated six MHz channel. To achieve this unexpected result, I have found that the FM signal must be located with its peak value between 50 and 400 kilohertz (KHz) below the high end, or above the low end, of the channel, and, further, must have power no greater than 4 times the power of the ditgital signal.

What is claimed is:

1. A digital television (DTV) broadcasting station which, in addition to the digital TV signal, broadcasts one or more analog frequency modulated (FM) radio signals, both the TV and the FM sharing the same allocated six megahertz wide channel.

2. The DTV station described in claim 1, in which the peak value of the FM radio signals are located between 50 and 400 kilohertz above and/or below the channel edges.

3. The DTV station described in claim 2, which broadcasts between 82 and 88 megahertz, and in which the peak values of the added FM signals are between 87.74 and 87.76 megahertz.
